(19) United States
(12) Patent Application Publication
(10) Pub. No.: US 2013/0206266 A1
(43) Pub. Date: Aug. 15, 2013

(54) Recycled Water Storage System for Vehicle Windscreen Cleaning

(71) Applicant: David Stenhouse, Grimsby (GB)

(72) Inventor: David Stenhouse, Grimsby (GB)

(21) Appl. No.: 13/702,698

(22) PCT Filed: Jun. 6, 2011
(86) PCT No.: PCT/GB2011/051062

§ 371 Date: Mar. 21, 2013

(30) Foreign Application Priority Data
Jun. 7, 2010 (GB) 1009423.3

(51) Int. Cl. B60S 1/50

(52) U.S. Cl. CPC B60S 1/50
USPC 137/899.4

(57) ABSTRACT

An apparatus (10) for providing recycled water to a vehicle windscreen washing system that has a washing fluid tank (11) and pump means (12) for pumping water from the tank (11) to outlet jets (13) directed at the windscreen. The apparatus comprises a water extractor (14) operable to extract water from atmospheric air and collect the extracted water in a chamber (15), and means for supplying the collected water from the chamber (15) to the tank (11) to refill the tank. A filtration and water purifying system comprising filters and ultraviolet light source may be provided to purify the condensed water.

The present invention relates to vehicle windscreen cleaning systems and in particular to storing and using recycled water for cleaning windscreens of vehicles. In particular, although not exclusively, the present invention relates to a water recycling system that can be retrofitted to an existing vehicle easily. In this context the term vehicle refers to any type of vehicle such as, for example, cars, lorries, military vehicles such as tanks and armoured vehicles, and railway engines.

Conventionally windscreen washer systems are filled using processed potable water from domestic drinking water supplies. This usually entails opening the bonnet (sometimes called “hood”) of the vehicle and manually pouring the water into the windscreen washer bottle or windscreen washer container of the vehicle. Often a surfactant or detergent is added to the bottle. In most systems the expensive water is used once and the washer bottle requires frequent refilling. Often the supply of water runs out at inconvenient times and this is particularly galling at times when it is raining, when queuing at service stations, or when wearing good clothes or when getting dirty fingers would be impractical.

Processed water is becoming very costly and it has been estimated that occurrences of drought in many countries is likely to escalate due to problems associated with global warming, that imposition of bans on the extravagant use of processed water supplies will force the need to conserve the use of such water supplies for uses such as cleaning vehicle windscreens. It is becoming clear that new technologies are needed in some situations and indeed in some countries water is becoming a rare commodity and the occurrences of drought mean that water supplies may not be as readily available in the future.

There have been many proposals in the past for recycling rainwater falling on the vehicle to clean the windscreen of the vehicle by refilling the washer bottle of the vehicle. For example, DE 4101820 (Ernst) discloses a rainwater recycling system in which rainwater is collected, filtered to remove debris, and stored in an auxiliary tank (A) that has an overflow pipe (U). The rainwater collected in the auxiliary tank (A) is pumped to the main washer bottle (B) of the vehicles windscreen washer system where it can then be pumped to the water jets directed at the vehicles windscreen. Another example of a rainwater collection system is described in DE 202004013436 (Krieg), which discloses rainwater feed line for replenishing a windscreen washing fluid reservoir. The feed line comprises an integrated fine filter and is connected at one end via a branch to a drain trough for collecting rainwater, and at its other end into the reservoir. Thus, when rain falls, the reservoir is refilled. Between falls of rain, the reservoir supply is diminished each time the windscreen is cleaned.

Similarly, DE 4436023 (Wirsig) discloses a method and device for the automatic filling of a vehicle's windscreen washing fluid reservoir using rainwater collected from the windscreen of the vehicle. A funnel is disclosed to collect rain during rainfall. The rain is directed via a hose to the car's existing reservoir, to fill the reservoir. If the reservoir becomes completely filled, excess rainwater flows over the top of the funnel and proceeds along its natural route towards the road.

In a more complex system, DE 433,0724 (Zymelka) discloses an entire window-washing system for motor vehicles. The system comprises a container for the washer fluid; a water pump for feeding the washer fluid to washer jets; hose lines along which the fluid travels between components; and wiper arms driven by a wiper motor and to which wiper blades are fastened. To recover at least some of the washer fluid used during window cleaning, and some rain water, provision is made for a collecting device to collect washer fluid and rain water from the window, from which collecting device the collected fluid is passed into the fluid container; the fluid container being fitted with an overflow.

It can be seen from the forgoing that these prior known systems work reasonably well to replenish the water during rainfall but a need has arisen to supply a reliable flow of recycled water to a windscreen washing fluid system that would be available at times other than during rainfall. Furthermore, at times when rainfall is infrequent, such as during summer time or in drought conditions, or in those climates where rainfall is diminished or non existent there is a need to be able to replenish the water reservoir without the need to fill it from expensive processed water supplies.

Water vapour is in abundant supply in atmospheric air, At any given time, It is estimated that earth's atmosphere contains approximately 3.4 quadrillion (or 3.4 trillion) US gallons of vapour form, this may sound a lot but compared to the world's total watershed it represents approximately 0.001%. The key is that the water in the atmosphere regenerates as a form of recycling of the earth's oceans and fresh ground water. Therefore, so long as there is water on earth, there will be water in the atmosphere. We do not need to be concerned with the quality or type of ground water sources that are evaporating because only H₂O molecules end up as vapour. Therefore, it would be advantageous to have a system for using recycled water extracted from atmospheric air either to supplement or to replace rainwater collection systems for washing a windscreen.

Typical temperatures and humidity levels in the UK range from the lowest temperatures in January of about 1 to 6° C. with relative humidity of 89%, to the highest temperatures in July/August of about 12 to 21° C. with an average relative humidity of about 77%. Thus the present invention offers the opportunity to extract reasonable quantities of water most of the year even during periods on long periods of drought.

An object of the present invention is to provide a water recycling system that has a water extraction system for supplementing or replacing rainwater collection systems for vehicle windscreen washing systems.

A further object of the present invention is to provide such a recycling system that can be retrofitted to a vehicle. An advantage of this is that it minimizes the necessary expenditure for a user with an existing vehicle having an existing windscreen washing fluid system. It would be further advantageous for such a system to fit a variety of models of vehicles. It would be yet further advantageous for such a system to occupy minimal space and weight in a vehicle and not to alter the shape of the vehicle.

According to the present invention there is provided an apparatus for providing recycled water to a vehicle windscreen washing system that has a washing fluid tank and means for pumping water from the tank to outlet jets directed at the windscreen, the apparatus comprising a water extractor operable to extract water from humid atmospheric air and collect the extracted water in a chamber, and means for supplying the collected water from the chamber to the tank to replenish water in the tank.

The water extractor may be incorporated in a rainwater collection system that has reservoir adapted to collect and store rainwater that falls on the vehicle. In this case the water collection chamber may be connected to a rainwater collection reservoir adapted to collect and store rainwater. Alternatively the water collection chamber constitutes the rainwater collection reservoir.

According to one aspect of the present invention the water extractor is a dehumidifier of the type that uses a refrigerant, a compressor to compress the refrigerant and an evaporative cooler to cool the air flowing in contact with the cooler to below its dew point, and thereby condense water from the air.

Alternatively the water extractor may be of the type that uses a thermoelectric Peltier cooling effect to cool a heat sink and thereby cool the air those contacts the heat sink to below its dew point to condense water from the air.

In a further embodiment of the invention the water extractor may be of the type that uses a desiccant wheel.

In yet a further aspect of the present invention the water extractor may be in the form of a turbine having turbine blades that have an aerodynamic profile that creates a depression in pressure of air flowing over the turbine blades in the wake of the turbine blades and thereby causes the water to evaporate in the air flow and a cooling means is provided to condense and collect the vaporized water from the air flow. In this case the turbine is preferably located in a forward facing air intake and is driven by ram airflow as the vehicle is driven forwards. In a modification, an electric motor may be provided for driving the turbine when there is insufficient ram airflow to drive the turbine. Preferably the electrical motor is connected to an electrical circuit of the vehicle so that it is only powered when the engine of the vehicle is running.

Preferably a pump is provided for pumping condensed water from the chamber through a hose to a rainwater reservoir.

Preferably a level detector is provided in the chamber that is operable to control the operation of the compressor of the water extractor so that the water extractor only runs when the reservoir needs to be topped up.

It is preferred that the compressor is connected in an electrical circuit of the vehicle so that it is only powered when the engine of the vehicle is running.

Preferably the water extractor has an air filter in an air intake of the water extractor to remove air-borne particles in the air. The filter may be an electrostatic filter.

Preferably a filtration system is provided through which the condensed water flows. The filtration system may include an ultraviolet light source for irradiating the condensed water. A sediment screen may be provided for filtering the condensed water. The filtration system may include carbon blocks through which the water flows. The collected water may be subjected to an ozone treatment to produce drinkable water that is available for occupants of the vehicle.

Where the apparatus includes a rainwater collection system the rainwater collecting means comprises a funnel and preferably incorporates a filter.

An advantage of one embodiment of the present invention is that it fits a variety of cars, thus one version can be manufactured and sold to owners of many types of vehicles, reducing manufacture costs. A further advantage is that it can be retrofitted to a user's existing vehicle, minimizing expenditure for the vehicle owner.

The present invention will now be described by way of examples with reference to the accompanying drawings in which:

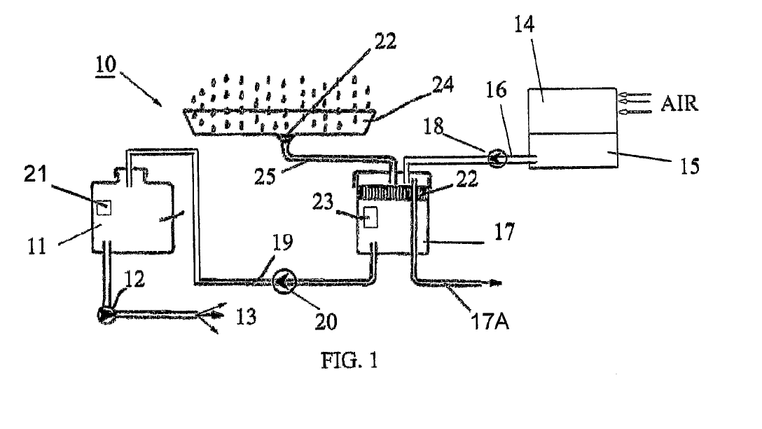

FIG. 1 shows one embodiment of an apparatus constructed in accordance with the present invention for providing recycled water to a vehicle windscreen washing system;

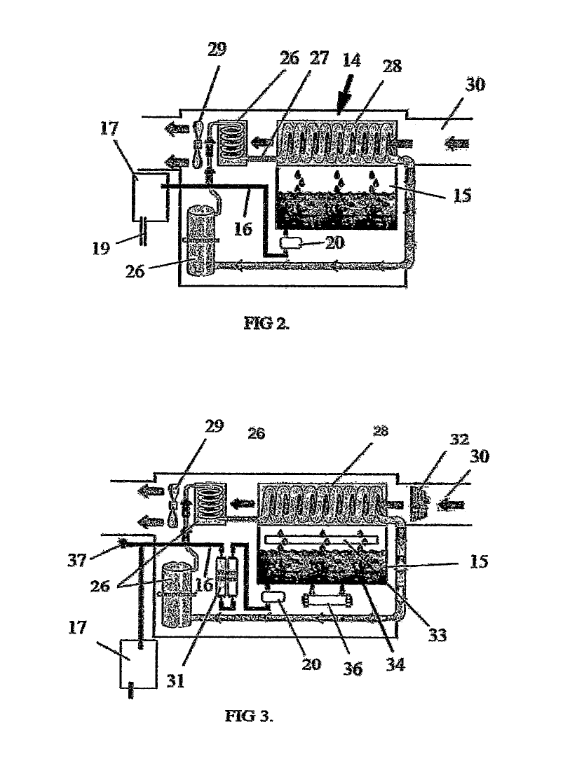

FIGS. 2 and 3 illustrate schematically water extractors of the type that uses a compressor and evaporative cooling cycle for use in the apparatus shown in FIG. 1;

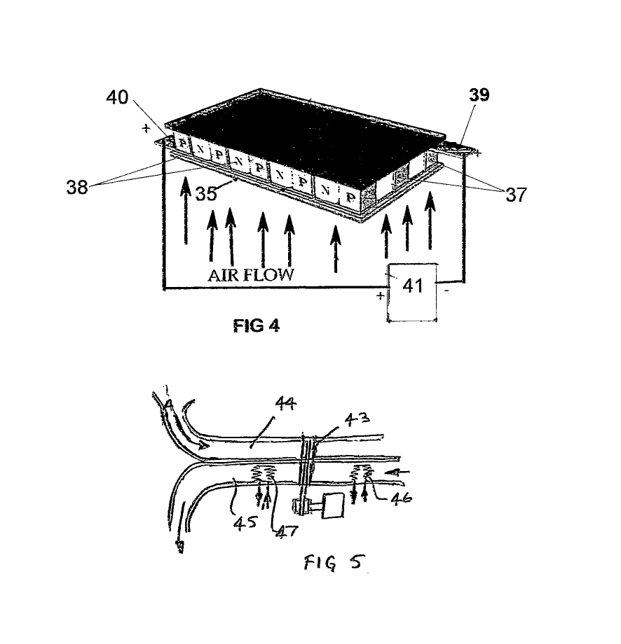

FIG. 4 illustrates a water extractor in the form of a Peltier Cooling device for use in the apparatus of FIG. 1; and

FIG. 5 illustrates schematically a water extractor in the form of a dessicant wheel type.

Referring to FIG. 1, there is shown an apparatus 10 that can be retrofitted to a vehicle that has a conventional windscreen washing system that comprises a washer tank 11 and a pump 12 for pumping washing fluid (usually a mixture of water and a surfactant or soap or detergent) to water jets 13 directed at the windscreen of the vehicle.

The apparatus 10 comprises a water extractor 14 that extracts water from the atmospheric ambient air and collects the extracted water in at least one chamber 15 that is an integral part of the water extractor 14 such as a sump. An electrically driven pump 18 pumps condensed water from the chamber 15 of the water extractor 14 through a first hose 16 to an auxiliary reservoir 17. The first hose 16 discharges into the top of the reservoir 17 at the top of the reservoir. The reservoir 17 has a second hose 19 connected to the washer tank 11 of the vehicle through which water can be supplied to the washer tank 11.

If the reservoir 17 is located lower than the washer tank 11 so that the water cannot flow by gravity feed to the tank, the water can be pumped to the tank 11 from the reservoir 17 by an electrically driven pump 20. In this latter case, a float switch 21, or another type of liquid level detector, is provided in the washer tank 11, to control operation of the pump 20 to pump water from the reservoir 17 to washer tank 11 when the level in tank 11 falls below a predetermined level. An overflow hose 17A is provided at the top of the reservoir 17 to allow water collected in the reservoir 17 to overflow and be discharged. The inlet end of the hose 17A terminates inside the reservoir 17 at the top of the reservoir 17 to maximise the amount of water that can be collected from the reservoir 17.

A float switch 23, or another type of level detection switch, is provided in the reservoir 17 and this is operable to control the operation of the water extractor 14 so that the water extractor 14 only runs when the level of water in the reservoir 17 is below a predetermined level.

Preferably the water extractor 14 is located where it can draw in ambient humid air through a suitable air intake. For example, where there is sufficient space, the water extractor 14 could be located at the front of the vehicle. For example, in a car it could be located behind a front body panel, front skirt, or front bumper region, of the vehicle. It could be located anywhere where it can draw in ambient air.

Optionally, the water extractor 14 is incorporated in a system that includes a rainwater collecting means 23 in the form of a funnel 24 that is connected by means of a third hose 25 to the reservoir 17. Preferably a filter 22 is provided at the outlet of the funnel, and/or it could be located inside the reservoir 17 to prevent debris being washed by the rainwater into the reservoir 17 and blocking the flow of water from the reservoir 17.

The filter 22 may be a mesh or any filtering means known in the art, and may be disposable or reusable. It is preferred that the water extractor 14 is connected to an independent reservoir 17 as shown in FIG. 1. Alternatively, the reservoir 17 could be dispensed with and incorporated in the water collection chamber 15 of the water extractor 14.

Suitable water extractors 14 are shown schematically in more detail in FIGS. 2 to 5.

Referring to FIG. 2, the water extractor 14 is a dehumidifier of the type that uses a refrigerant and compressor 26 to compress the refrigerant, a capillary tube 27 and an evaporative cooler 28, to cool the ambient humid air drawn by an electrically driven fan 29 in through an air intake 30 to below its dew point, and thereby condense water from the air. The condensed water is collected in the collection chamber 15 close to the evaporative cooler 28 and pumped by means of the pump 20 via the hose 16 to the reservoir 17 to top up the reservoir 17 of the apparatus of FIG. 1. The level detector 23 in the reservoir 17 controls the operation of the compressor 26 of the water extractor 14, so that the water extractor 14 only runs when the reservoir 17 needs to be topped up. The compressor 26 and fan 29 of the water extractor 14 is connected in an electrical circuit of the vehicle (not shown) so that it is only powered when the engine of the vehicle is running.

An example of water extractor 14 that may be suitable is a humidifier that is sold by Force 4 Chandlery under the model name Ultra Compact and Product Code No 810018. This model operates from a power supply of 12 volts DC and will extract up to 250 ml of water a day from air above 15° C. having a relative humidity of 40% or more.

As shown in FIG. 3 the water extractor 14 could be more sophisticated than that shown in FIG. 2, in that it may be one that extracts purified water from atmospheric air. The water extractor 14 of FIG. 3 is similar to that shown in FIG. 2 and similar parts are given the same reference numbers. However, the water extractor 14 of FIG. 3 draws air through an air intake filter 32 such as for example an electrostatic filter located in the air intake 30, to remove most of the air borne particles in the air. The extracted water is collected in the collection chamber 15 and is passed under an Ultraviolet (UV) light source 33 in the chamber 15 where the water is irradiated with the UV rays that kill germs and bacteria in the collected water. The water in the chamber 1 is re-circulated through Ultraviolet rays 33 and treated by ozone at an ozone treatment zone 36.

The purified water in chamber 15 passes through a sediment screen 34 and is pumped by the electrically driven pump 20 through a second filtration system 31 such as carbon blocks or further Ultraviolet light filters. If desired. part of the treated water can be directed to a drinking water dispensing tap 37 that is accessible by the occupants of the vehicle (particularly useful in hot environments inside a military tank). The dispensing tank 33 could be a chilled tank (not shown).

It will be appreciated that the water extractor 14 shown in FIG. 3 not only provides the added feature of being able to supply cooled drinking water “on tap” to users of the vehicle, but also has the advantage of reducing pathogens and bacteria that could otherwise accumulate in the chamber 15 or reservoir 17 as might happen where non purified recycled water is simply reused over and over again to top up the reservoir 17 in the embodiment using a rainwater collection system.

An example of such an air to water extractor 14 that extracts drinkable water is that made by Air2Water Global Inc. under the model name Dolphin 1, which, in it's present state generates up to 22 litres of water a day from ambient air at 15° C. or above with a relative humidity of 35 to 95%. This product would have to be greatly reduced in size for some applications and converted to a 12-volt power supply to fit into a motor vehicle but illustrates the sort of extra treatments that are possible to produce drinking water.

A further type of water extractor 14 that may be suitable for use in the present invention is that which uses a thermoelectric Peltier cooling effect (See FIG. 4) to cool a heat sink 35 that is contacted by humid atmospheric air thereby to cool the air to below its dew point and condense water from the air. The Peltier device comprises a plurality of n type and p type thermoelectric elements 37, 38 interconnected by connections 39, 40 connected to a battery 41 (which may be the vehicle's battery). Although Peltier cooling devices may not be as efficient as, for example, an evaporative refrigeration system, they have the advantage of being light weight and relatively cheap. An example of a Peltier type device is that made by WinEurope SA under the Model name Purline Miny 300 dehumidifier. This unit uses a Thermo-electric Peltier cooling module drawing 60W from a 12 Volts DC 5A power supply and is capable of drawing water from air above 15° C. with relative humidity of over 40%, and will extract up to approximately 250 ml of water per day from atmospheric air at 30° C., 80% relative humidity.

A further type of known water extractor 14 that may be suitable for use in the present invention is the type known as a dessicant wheel. This is shown schematically in FIG. 5. Referring to FIG. 5 there is shown a wheel 43 (there may be a bank of two or more such wheels (not shown)) that is water absorbent or hygroscopic. The, or each wheel 43 may be made from a porous, or air permeable substrate that is coated with, or contains silica gel. Other desiccant or hygroscopic materials may also be suitable. The, or each, wheel 43 is located co-axially in two discrete separate air flow channels 44. 45, with the plane of the disc of the, or each, wheel (43) lying normal to the flow of air through the channels 44, 45. The, or each, wheel 43 is positioned so that it lies normal to the air channels and is driven by a motor so that the one or more wheels (43) rotate.

Incoming moist air (shown by arrow A) is caused to flow along one of the channels 44 by an electrically driven fan 29 and through the part of the one or more wheels 43 in the channel 44. Water within the airflow in channel 44 is absorbed by the desiccant or hygroscopic part of the, or each, wheel 43 that is exposed to the flow of incoming air. As the moistened wheel, or wheels 43 rotate, the moistened part of the wheel, or each wheel 43 is brought into the path of a second flow of air flowing in channel 45.

A second flow of air that is used to “dry” the one or more dessicant wheels is created either by recalculating the air flowing out of the channel 44 after it has given up the water to the one or more wheels (44), or by using a discrete second flow of air (in this case a second fan may be provided to move the air along the channel 45).

The “drying air” is caused to flow through a first heat exchanger 46 which heats the air and then through the moistened bottom section of the, or each, wheel 43 to remove the water from the one or more wheels (43). The moisture in the second flow of air is extracted by cooling it to below the dew point of the air, by passing it through a second heat exchanger 47. The condensed water is collected in a sump 15 of the apparatus shown in FIGS. 1 to 3.

It may also be possible to use a water extractor 14 in the form of a wind turbine of the type described in International Patent application publication WO 2006/017888 but I have not experimented with this type of water extractor. This type of wind turbine uses a centripetally pumped refrigeration cycle as an evaporative cooler to cool humid air and thereby condense water from the air. The condensed water may be collected in a chamber similar to the chamber 15 described above and supplied to the reservoir 17.described above. In the present invention the wind turbine would need to be modified so that the turbine is located in a forward facing air intake that allows the turbine to be driven by a ram air flow entering the intake as the vehicle is driven instead of relying on the wind alone to drive the turbine. Furthermore, an electrical motor may drive the turbine via an electromagnetic clutch that is engaged to drive the turbine when the ram airflow is insufficient to drive the turbine.

The following table shows the rainwater collection in litres over during 2009 on a static windscreen of a Peugeot 607 car in the Grimsby area of the United Kingdom. Each row in the table shows the time that rain fell and the amount collected in litre. Over this period a total of 79.73 ltrs was collected and the inventor used about 12.3 litres over the same period in a Peugeot 607. If these figures are extrapolated to the whole of the UK, and assuming only 25% of the UK market of 8,000,000 vehicles had a rainwater collection system, and used 2 litres of water per month, then this represents a saving of up to 16 million litres of water a year. The potential saving worldwide would be enormous.

| March | April | May | June | July |
|---|---|---|---|---|
| 3 Hrs/1.14 | 5 hrs/ | 5 hrs/0.9 ltrs | 2 hrs/2.2 ltrs | 1.5 hrs/3.1 ltrs |
| ltrs | 3.7 Ltrs | | | |
| 3 hrs/1.12 | | 7 hrs/7.95 ltrs | 2 hrs/2.44 ltrs | 2 hrs/3.3 ltrs |
| ltrs | | | | |
| 3 hrs/0.9 ltrs | | 2 hrs/2.84 ltrs | 5.5 hrs/7.38 ltrs | 2.5 hrs/4.7 ltrs |
| 5 hrs/5.68 | | 3 hrs/6.82 ltrs | | 3 hrs/5.2 ltrs |
| ltrs | | | | |
| | | 6 hrs/7.3 ltrs | | 40 mins/6.2 ltrs |
| | | | | 4 hrs/6.2 ltrs |
| | | | | 1.5 hrs/2.9 ltrs |
| | | | | 1.25 hrs/1.8 ltrs |

The rainwater collecting means described above is preferably a conical funnel 24 or another shape of open vessel, and preferably has a wide and open top surface to collect maximum rainfall. More important though is the positioning of the collecting means, since most rain collected will fall on other parts of the car, in particular the windscreen. Thus a preferred position of the collecting means is at the bottom of the windscreen, more preferably to one side of the windscreen of the vehicle. An advantage of this is that the water falling on the windscreen is swept by wipers and/or directed by gravity to the bottom of the windscreen, where gravity takes it to an edge of the windscreen. It may be advantageous to provide deflectors at the side edges of the screen to minimize the amount of rainwater that is thrown from the screen by the sweep of the screen wipers.

The rainwater collecting means is preferably disposed under the bonnet (or hood) of the vehicle and collects the rainfall from the windscreen via louvers, drainage channels present in most cars at this location. An advantage of this is that the apparatus 10 of the present invention affects neither the appearance nor the aerodynamics of the vehicle. There may be more than one rainwater collecting means positioned at locations around the car where water can be collected and directed via extra hoses (not shown) to the reservoir 17. For example and without limitation, two funnels 24 may be present; one at each side of the bottom of the windscreen or water may be collected at other locations such as at the rear of the vehicle. As a further alternative, the collecting means may be gutters, pipes, or other vessels or means of collecting water falling on and around a vehicle.

The hoses 16, 19, 21 and 25 may be rigid pipes although preferably the hoses are thin flexible hoses. An advantage of flexible hoses is that they can be bent to fit around the other components of the vehicle (for example the components under the bonnet (hood) of a vehicle). Furthermore, this gives more flexibility in where the other components such as the pumps, reservoir, rainwater collecting means, etc. can be disposed within the vehicle. The hoses may be connected to the other components of the apparatus my any means known in the art, which means may be temporary or permanent.

The reservoir 17 is preferably one litre in capacity for a motor car since this is a volume large enough to ensure that water is available to the windscreen washer fluid reservoir upon demand a large proportion of the time, even in dry weather, but a small enough volume not to occupy a large amount of space or weight within the car, both of which are at a premium in a car to ensure optimal vehicle performance. Preferably the rainfall reservoir is constructed from PVC, which is lightweight, since weight is at premium in a vehicle, as well as inexpensive and waterproof.

Alternatively other materials may be used. Furthermore, the reservoir may be of a larger or smaller capacity and may be any shape. It may be designed to fit on top of the vehicle or in any location on or in the vehicle. Alternatively, the overflow outlet may comprise a pressure sensitive valve and begin drainage when the valve detects fullness of the rainfall reservoir. As a further alternative the overflow outlet may simply be located at the top of the rainfall reservoir and thus be the natural path of overflowing water when the rainfall reservoir is full.

The reservoir 17 may also comprise self-gripping hose fittings for connecting the hoses to the reservoir, as known in the art.

The reservoir 17 preferably further comprises at least one bracket for affixing the reservoir to the vehicle. The bracket or brackets preferably comprise a multiplicity of fixing holes, preferably of different shapes, diameters, and positions, to enable fixing to a variety of different models of vehicles, since the underside of each type of vehicle's wheel arch will be different in construction and dimensions. An advantage of this is that the apparatus can be retrofitted to a user's existing vehicle.

The brackets are preferably moulded together with the reservoir and as such are PVC also. Alternatively, they may be a separate unit screwed, glued, welded or otherwise attached as known in the art to the reservoir and may be any material and construction known in the art.

The pump preferably comprises at least one bracket for affixing the pump to the car. The bracket or brackets preferably comprise a multiplicity of fixing holes, preferably of different shapes, diameters, and positions, to enable fixing to a variety of different models of cars or vehicles, since the location of the pump in each type of vehicle will be different in construction and dimensions. An advantage of this is that the apparatus can be retrofitted to a user's existing vehicle.

The brackets may be moulded together with the pump or may be a separate unit screwed, glued, welded or otherwise attached as known in the art to the reservoir and may be any material and construction known in the art.

The cap connecting means is disposed at the end of the hose 19 and connects the outlet of the pump 20 to the filler cap of the windscreen washer fluid tank 11. The term “filler cap” is used herein to mean the closure that is normally fitted to the filler opening of the tank 11 through which windscreen washing fluids such as water and cleaning agents are normally manually poured into the windscreen washing fluid reservoir. The cap may be any means known in the art for creating a watertight connection between a hose and an aperture. Preferably, the cap is stepped, conical, or otherwise adapted to accommodate caps of different diameters and therefore facilitate use in a variety of vehicles having different sized filler caps. Such connecting means are known in the art and any may be used.

It should be noted that if, for any reason, such as prolonged drought or infrequent use of use of the vehicle to extract sufficient water from the atmosphere, a need arises to top up or fill water or cleaning agents into the windscreen washer fluid reservoir 17, this can be done simply by pouring the fluid either directly into the tank 11, or into the rainfall collecting means, where fitted. Furthermore, where a rainwater collection system is incorporated, water or washing fluid may even be poured over the car or in any drainage channels of the vehicle from which the rainfall collecting means collect rainwater. An advantage of this is that there is no need to open the bonnet or the washer fluid reservoir as would be necessary in the absence of the rainwater collection apparatus.

In the above-described embodiments the fans 29 and 46 and the compressor (where fitted) or Peltier cooling device 38 (where fitted) of the water extractor 14 are electrically driven. This is preferred, because it is relatively easy to retrofit the water extractor to an existing vehicle. In this case the water extractor 14 can be readily connected in an electrical circuit that only operates when the engine of the vehicle is running. It is to be understood that the water extractor may be provided with its own rechargeable battery, such as for example a Lithium Ion Polymer battery (LiPo battery) so that the water extractor can run even when the engine of the car is not running. It may be possible to provide a solar powered generator to recharge the LiPo battery, although this may not be very practical for some high powered LiPo batteries that require a significant power charge beyond the present capabilities of reasonable sized solar power generators.

The water extractor fans 29 and 46 and the compressor (where fitted) or Peltier cooling device 38 (where fitted) may be driven directly by the engine of the vehicle by means of a belt drive or chain drive (or shaft drive). This would be easier to design into a new vehicle than into an existing vehicle. In this case there may be an electromagnetic clutch in the transmission train between the engine and the fans and compressor that is operable to disengage the drive to the fans and compressor when the tank 17 is full.

The present invention is also applicable to electrically powered vehicles, but in this case it would be better not to run the water extractor 14 from the vehicle's battery when the vehicle is stationary.

1-20. (canceled)

21. An apparatus for providing recycled water to a vehicle windscreen washing system that has a washing fluid tank and pump means for pumping water from the tank to outlet jets directed at the windscreen, the apparatus comprising a water extractor operable to condense water from humid atmospheric air, a water collection means for collecting the extracted water in a chamber, and supply means for supplying the collected water from the chamber to the tank to replenish water in the tank, wherein the water extractor is incorporated in a rainwater collection system that has rain water collection means adapted to collect rain water that falls on the vehicle and supply it to the tank.

22. Apparatus according to claim 21 wherein the rain water collection means is connected to a rainwater collection reservoir adapted to collect and store rain water.

23. Apparatus according to claim 21 wherein the rain water collection means constitutes the rainwater collection reservoir.

24. Apparatus according to claim 21 wherein the water extractor is a dehumidifier of the type that uses a refrigerant, a compressor for compressing the refrigerant, and an evaporative cooler for cooling the air flowing in contact with the cooler to below its dew point, and thereby condense water from the air.

25. Apparatus according to claim 21 wherein the water extractor is of the type that uses a thermoelectric Peltier cooling device for cooling a heat sink and thereby cool the air that contacts the heat sink to below its dew point to condense water from the air.

26. Apparatus according to claim 21 wherein the water extractor is of the type that comprises one or more desiccant wheels through which moist air from which water is to be extracted is flowed through the one or more desiccant wheels.

27. Apparatus according to any one of claim 26 wherein the water extractor comprises a first channel through which an incoming flow of moist air from which water is to be extracted flows, a second channel through which a drying fluid flows, one or more wheels being made of a hygroscopic or water absorbent material extending transverse to the first and second channels and being rotatable so that moisture collected from the moist air is carried by the one or more wheels into the flow of drying air to remove the moisture from the one or more wheel, and means are provided to collect the extracted water.

28. Apparatus according to claim 27 wherein heating means is provided in the second channel to heat the air flow prior to passing the air flow through the one or more wheels and a cooling means is provided in the second channel for cooling the air flow leaving the wheel and thereby condense water from the air flow.

29. Apparatus according claim 21 wherein a pump is provided for pumping condensed water from the chamber through a hose to a rainwater reservoir.

30. Apparatus according to claim 29 wherein a level detector is provided in the chamber that is operable to control the operation of the compressor of the water extractor so that the water extractor only runs when the reservoir needs to be topped up.

31. Apparatus according to claim 34 wherein the compressor is connected in an electrical circuit of the vehicle so that it is only powered when the engine of the vehicle is running.

32. Apparatus according to claim 211 wherein the water extractor has an air filter in an air intake of the water extractor that is operable to remove airborne particles from the air.

33. Apparatus according to claim 21 wherein an ultraviolet light source is provided for irradiating the condensed water.

34. Apparatus according to claim 21 wherein a filtration system is provided through which the condensed water flows.

35. Apparatus according to claim 34 wherein the filtration system includes a sediment screen is provided for filtering the condensed water.

36. Apparatus according to claim 34 wherein the filtration system includes carbon blocks through which the condensed water flows.

37. Apparatus according to claim 21 wherein the condensed water extracted from the air is subjected to an ozone treatment to produce drinkable water that is available for occupants of the vehicle.

38. Apparatus according to claim 21 wherein the rainwater collecting means comprises a funnel.

39. Apparatus according to claim 38 wherein the funnel incorporates a filter.
